(19) United States
(12) Patent Application Publication
(10) Pub. No.: US 2007/0256525 A1
(43) Pub. Date: Nov. 8, 2007

(54) Rotary wrench structure

(76) Inventor: Chang Chuan Lee, Caotun Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/797,513

(22) Filed: May 4, 2007

(30) Foreign Application Priority Data
May 5, 2006 (TW) 095116134

(51) Int. Cl. B25B 13/46; B25B 23/16; B25G 1/00

(52) U.S. Cl. 81/63.1; 81/177.7

(57) ABSTRACT

A rotary wrench structure including a main body and a working head. The main body has a handle section at one end and two lugs at the other end. The two lugs define therebetween a holding space. A split communicates with the holding space and extends therefrom to the handle section. The working head has a receiving space in which a ratchet head is accommodated. A stopper member is mounted at a bottom end of the ratchet head for locating the ratchet head. At least one cavity is formed on a sidewall of the receiving space, in which at least one pawl unit is mounted. The pawl unit includes a pawl block, a slide block and a resilient member. The pawl block has several ratchets and the slide block has an arced face. The pawl block and the slide block are interconnected by the resilient member. The ratchets of the pawl block serve to engage with the ratchets of the ratchet head for driving the ratchet head. The working head is rotatably connected with the lugs by connecting members, whereby the working head can be rotated relative to the lugs for multiangular operation. The ratchet head is formed with a central axial through hole in which a driving head is slidably fitted.

### BACKGROUND OF THE INVENTION

The present invention is related to a wrench structure, and more particularly to a two-way transmission rotary wrench structure.

FIG. 10 shows a conventional rotary wrench structure composed of a main body 5 and a working head 6. The main body 5 has a handle section 51 at one end and two lugs 53 at the other end. The two lugs 53 define therebetween a holding space 52. A split 54 communicates with the holding space 52 and extends therefrom to the handle section 51. The working head 6 has a receiving space 61 in which a ratchet head 62 and a direction-switching unit 63 are mounted. The direction-switching unit 63 has a pawl 631 for engaging with the ratchets 621 of the ratchet head 62. The direction-switching unit 63 is rotatable for switching the wrenching directions of the ratchet head 62. Two outer thread sections 64 with different screwing directions are arranged on the circumference of the working head 6. The outer thread sections 64 are screwed in the thread holes 55 of the lugs 53 to fix the working head 6 with the main body 5. A C-shaped retainer ring 65 is fitted around a bottom end of the direction-switching unit 63.

The pawl 631 of the direction-switching unit 63 is engaged with the ratchets 621 of the ratchet head 62 by an inclination. The engaged teeth are fewer so that the engaging area is smaller. Accordingly, the applied torque is reduced. Moreover, after a period of use, the pawl 631 and the ratchets 621 will be worn. In addition, it is necessary to rotate the direction-switching unit 63 for switching the wrenching directions. Such structure is more complicated so that the manufacturing cost is higher.

### SUMMARY OF THE INVENTION

It is therefore a primary object of the present invention to provide a rotary wrench structure in which the pawl block has more ratchets for engaging with the ratchets of the ratchet head by larger area. There is no direction-switching structure so that it is easier to assemble the components. Accordingly, the cost is lower and the structure is more durable.

According to the above object, the rotary wrench structure of the present invention includes a main body and a working head. The main body has a handle section at one end and two lugs at the other end. The two lugs define therebetween a holding space. A split communicates with the holding space and extends therefrom to the handle section.

The working head has a receiving space in which a ratchet head is accommodated. A stopper member is mounted at a bottom end of the ratchet head for locating the ratchet head. At least one cavity is formed on a sidewall of the receiving space, in which at least one pawl unit is mounted. The pawl unit includes a pawl block, a slide block and a resilient member. The pawl block has several ratchets and the slide block has an arced face. The pawl block and the slide block are interconnected by the resilient member. The ratchets of the pawl block serve to engage with the ratchets of the ratchet head for driving the ratchet head. The working head is rotatably connected with the lugs by connecting members, whereby the working head can be rotated relative to the lugs for multiangular operation. The ratchet head is formed with a central axial through hole in which a driving head is slidably fitted.

The present invention can be best understood through the following description and accompanying drawings wherein:

### BRIEF DESCRIPTION OF THE DRAWINGS

FIG. 1 is a perspective exploded view of a first embodiment of the present invention;

FIG. 2 is a sectional assembled view of the first embodiment of the present invention, showing the ratchet head and the pawl unit thereof;

FIG. 3 is a sectional view of the first embodiment of the present invention, showing that the driving head is fitted through the through hole of the ratchet head;

FIG. 4 is a sectional assembled view of the first embodiment of the present invention according to FIG. 2, showing that the ratchets of the pawl block are engaged with the ratchets of the ratchet head;

FIG. 5 is a perspective exploded view of a second embodiment of the present invention;

FIG. 6 is a perspective exploded view of a third embodiment of the present invention;

FIG. 7 is a perspective exploded view of a fourth embodiment of the present invention;

FIG. 8 is a perspective exploded view of a fifth embodiment of the present invention;

FIG. 9 is a sectional assembled view of the fifth embodiment of the present invention, showing that the operation thereof; and

FIG. 10 is a perspective exploded view of a conventional rotary wrench.

### DETAILED DESCRIPTION OF THE PREFERRED EMBODIMENTS

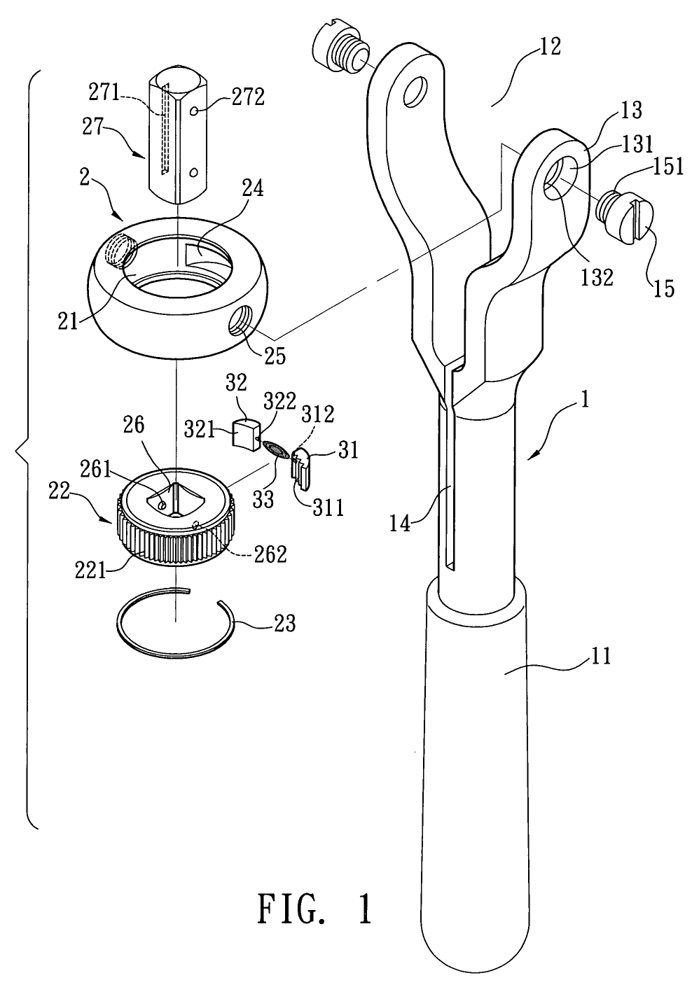

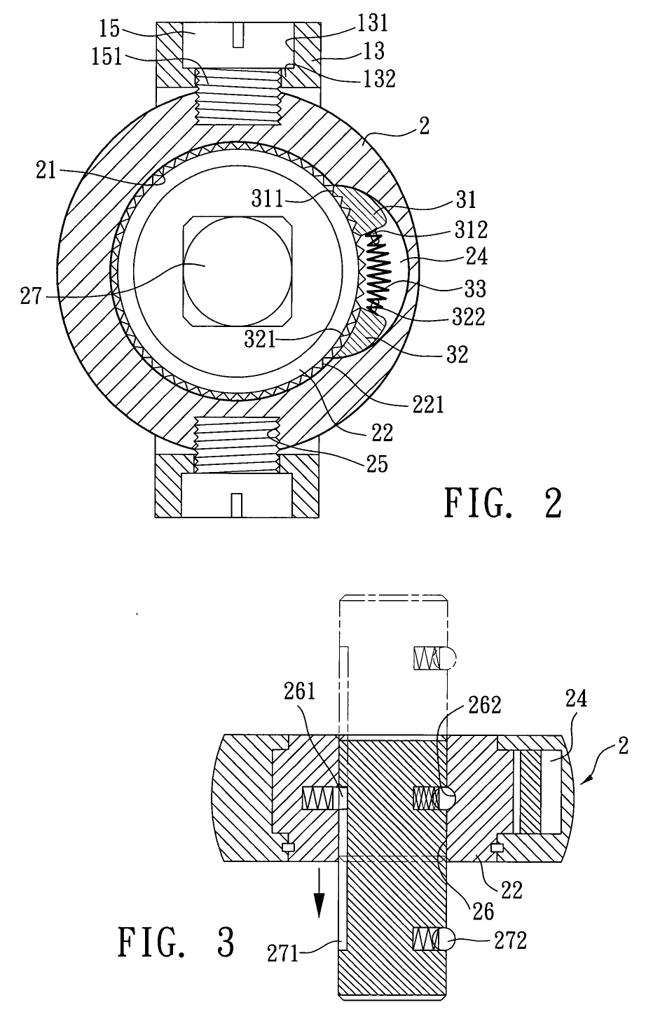

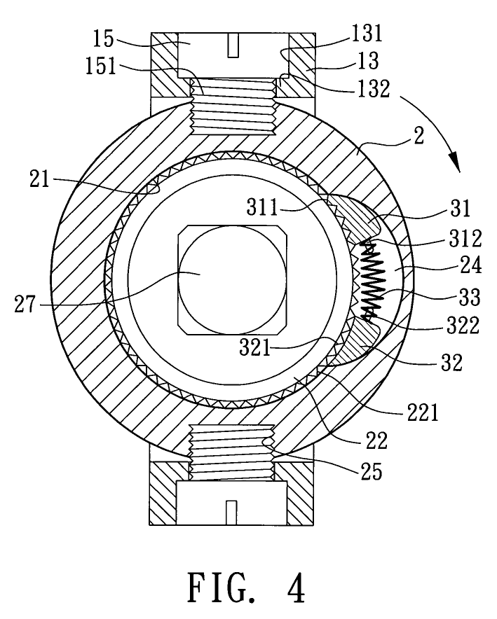

Please refer to FIGS. 1 to 4. The rotary wrench structure of the present invention includes a main body 1 having a handle section 11 at one end and two lugs 13 at the other end. The two lugs 13 define therebetween a holding space 12. Each lug 13 has a locating hole 131. Two opposite ends of the locating holes 131 respectively have two stopper flanges 132. A split 14 communicates with the holding space 12 and extends therefrom to the handle section 11.

The rotary wrench structure further includes a working head 2 having a receiving space 21 in which a ratchet head 22 is accommodated. The circumference of the ratchet head 22 is formed with multiple ratchets 221. A stopper member 23 is mounted at a bottom end of the ratchet head 22 for locating the ratchet head 22 in the receiving space 21. At least one (one in this embodiment) cavity 24 is formed on a sidewall of the receiving space 21. At least one (one in this embodiment) pawl unit 3 is mounted in the cavity 24. The pawl unit 3 includes a pawl block 31, a slide block 32 and a resilient member 33. In this embodiment, the resilient member 33 is a compression spring.

One side of the pawl block 31 is formed with several ratchets 311 facing the ratchet head 22. One side of the slide block 32 is formed with an arced face 321 facing the ratchet head 22. The opposite ends of the pawl block 31 and the slide block 32 respectively have a first boss 312 and a second boss 322. Two ends of the resilient member 33 are respectively fitted on the first and second bosses 312, 322 to interconnect the pawl block 31 and the slide block 32. The ratchets 311 of the pawl block 31 serve to engage with the ratchets 221 of the ratchet head 22 for driving the ratchet head 22.

The circumference of the working head 2 is formed with two inner connecting sections 25 respectively corresponding to the locating holes 131 of the lugs 13. In this embodiment, the inner connecting section 25 is an inner thread section. Two connecting members 15 are used to connect the working head 2 with the lugs 13. Each connecting member 15 has an outer connecting section 151 at one end. In this embodiment, the outer connecting section 151 is an outer thread section. The outer thread section is passed through the locating hole 131 of the lug 13 and screwed into the inner thread section of the working head 2. By means of the connecting members 15, the working head 2 is rotatable relative to the lugs 13 for multiangular operation.

In addition, the ratchet head 22 is formed with a central axial square through hole 26. A driving head 27 is slidably fitted in the through hole 26. A restricting member 261 is embedded in a sidewall of the through hole 26. One side of the driving head 27 is formed with a flute 271 facing the restricting member 261. The restricting member 261 is slidably inlaid in the flute 271. Another sidewall of the through hole 26 of the ratchet head 22 opposite to the restricting member 261 is formed with a second locating hole 262. Two resilient units 272 are embedded in another side of the driving head 27 opposite to the flute 271. In this embodiment, each resilient unit 272 includes a compression spring and a ball body. The driving head 27 can be slid within the through hole 26 of the ratchet head 22 to coaxially align one of the resilient units 272 with the second locating hole 262. At this time, the ball body can bound into the second locating hole 262 to locate the driving head 27.

In use, the driving head 27 is first adjusted to protrude one end of the driving head 27 from the ratchet head 22. Then a socket can be fitted on the driving head 27 for driving a work piece. Also, the angle contained between the working head 2 and the main body 1 is adjusted to proper force application angle. Thereafter, the handle section 11 can be clockwise wrenched. The pawl block 31 is pushed by the compression spring 33 so that the ratchets 311 of the pawl block 31 are engaged with the ratchets 221 of the ratchet head 22, whereby the work piece can be wrenched by the wrench.

Reversely, when loosening the work piece, the driving head 27 is first pressed. At this time, the ball body of the resilient unit 272 is pressed by the sidewall of the through hole 26 of the ratchet head 22 and retracted to get out of the second locating hole 262 of the ratchet head 22. The restricting member 261 of the ratchet head 22 slides along the flute 271 of the driving head 27, whereby the ball body of the other resilient unit 272 of the driving head 27 moves to the second locating hole 262 and bounds into the second locating hole 262 to locate the driving head 27. Thereafter, the wrench can be operated in the same manner to loosen the work piece.

According to the above arrangement, the pawl block has more ratchets for engaging with the ratchets of the ratchet head by larger area. There is no direction-switching structure so that it is easier to assemble the components. Accordingly, the cost is lower and the structure is more durable. In addition, the driving head can be slid and located at either end of the ratchet head 22 to switch the wrenching direction. This is convenient for a user to operate the wrench.

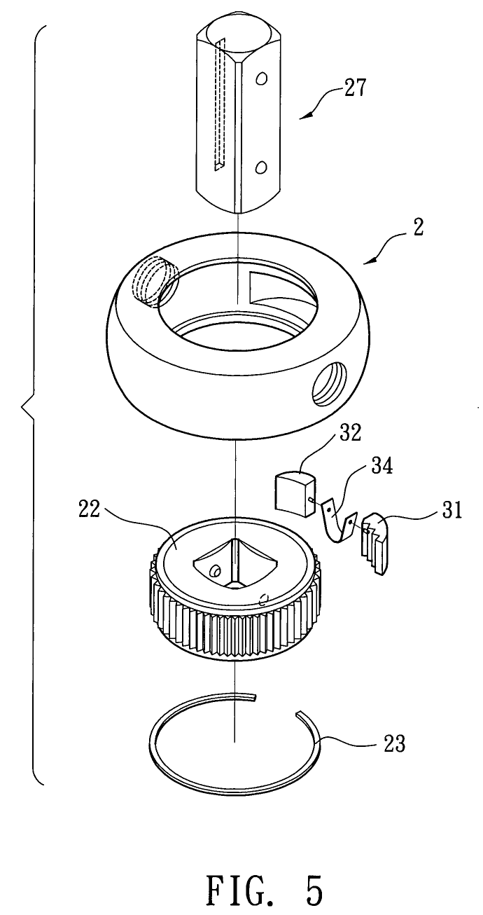

FIG. 5 shows a second embodiment of the present invention, in which the resilient member 34 is a U-shaped leaf spring.

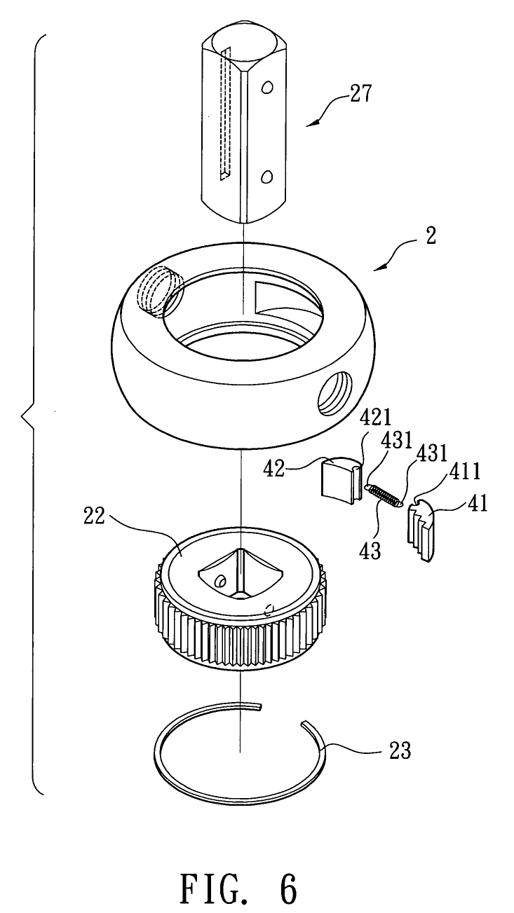

FIG. 6 shows a third embodiment of the present invention, in which the opposite ends of the pawl block 41 and the slide block 42 are respectively formed with two locating channels 411, 421. Each end of the resilient member 43 has a locating section 431. The locating sections 431 are respectively fitted in the locating channels 411, 421 of the pawl block 41 and the slide block 42 to achieve the same effect as the first embodiment.

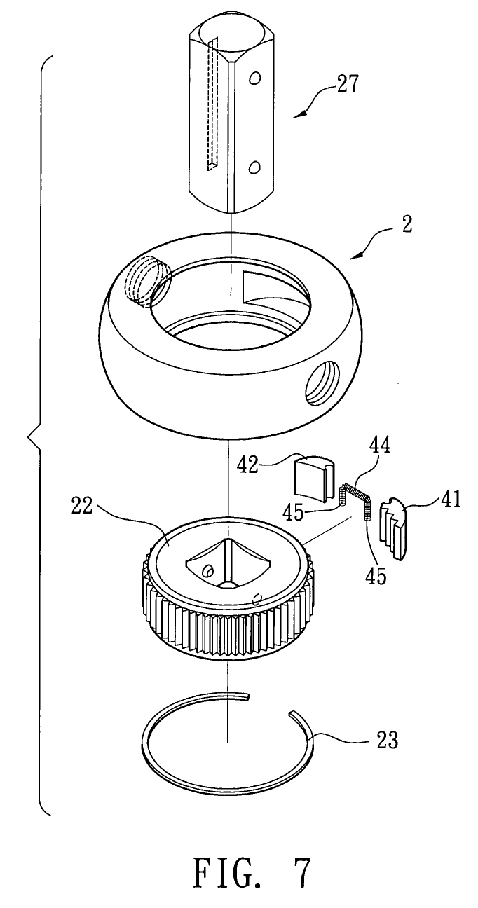

FIG. 7 shows a fourth embodiment of the present invention, in which the resilient member 44 is a U-shaped spring 45 to achieve the same effect as the first embodiment.

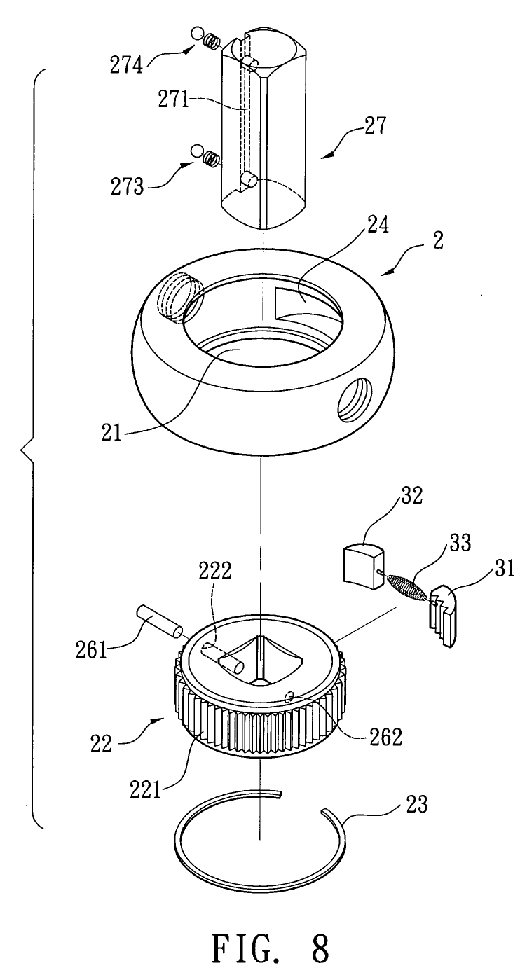

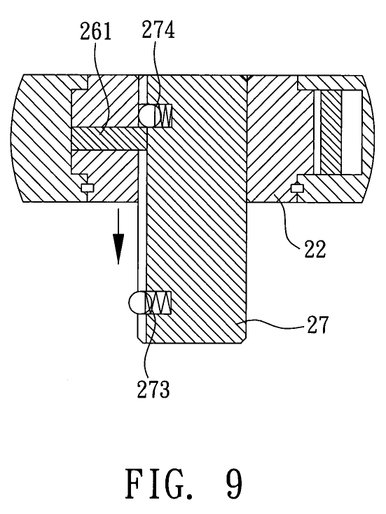

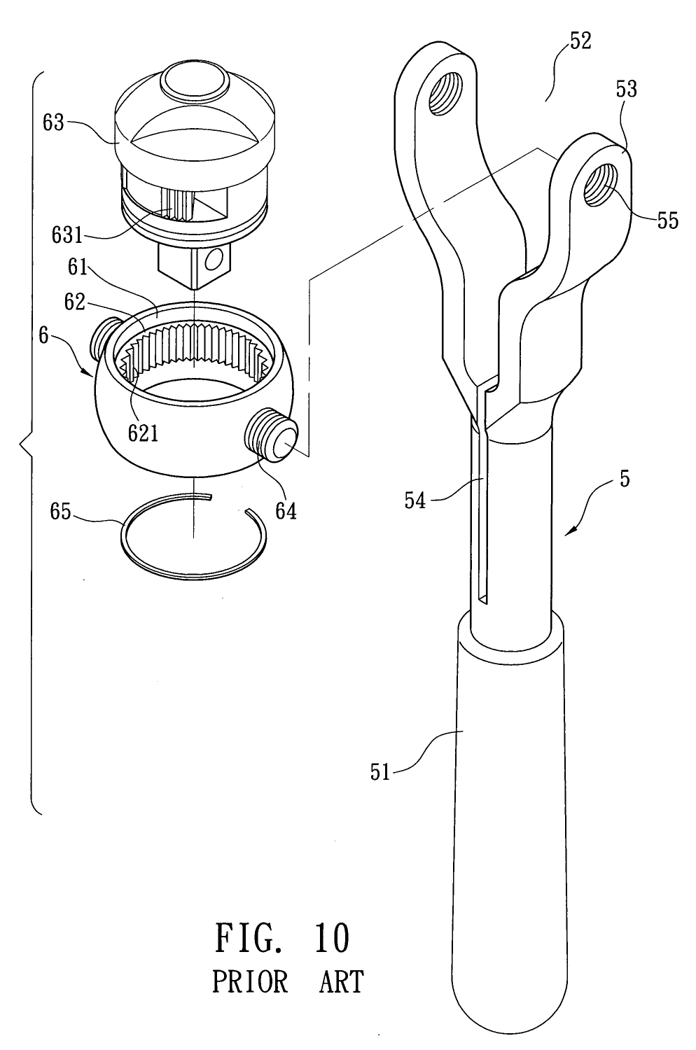

FIGS. 8 and 9 show a fifth embodiment of the present invention, in which the ratchet head 22 is formed with a radial through hole 222 in which the restricting member 261 is accommodated. In this embodiment, the restricting member 261 is an insertion pin. In addition, a second resilient unit 273 and a third resilient unit 274 are disposed in the flute 271 in proper positions. In this embodiment, each of the resilient units 273, 274 includes a compression spring and a ball body. The second resilient unit 273 is positioned near the bottom of the flute 271, while the third resilient unit 274 is positioned near the top of the flute 271. Accordingly, the second resilient unit 273 and the third resilient unit 274 define therebetween a restricting flute. The restricting member 261 is fitted in the restricting flute, permitting the driving head 27 to axially move between the second resilient unit 273 and the third resilient unit 274. The flute 271 can alternatively extend through the driving head 27 from the top to the bottom thereof.

The above embodiments are only used to illustrate the present invention, not intended to limit the scope thereof. Many modifications of the above embodiments can be made without departing from the spirit of the present invention.

What is claimed is:

1. A rotary wrench structure comprising:
a main body having a handle section at one end and two lugs at the other end, the two lugs defining therebetween a holding space, a split communicating with the holding space and extending therefrom to the handle section; and
a working head having a receiving space in which a ratchet head is accommodated, a circumference of the ratchet head being formed with multiple ratchets, a stopper member being mounted at a bottom end of the ratchet head for locating the ratchet head in the receiving space, at least one cavity being formed on a sidewall of the receiving space, at least one pawl unit being mounted in the cavity, the pawl unit including a pawl block, a slide block and a resilient member, one side of the pawl block being formed with several ratchets facing the ratchet head, one side of the slide block being formed with an arced face facing the ratchet head, the pawl block and the slide block being interconnected by the resilient member, whereby the ratchets of the pawl block serve to engage with the ratchets of the ratchet head for driving the ratchet head, the working head being rotatably connected with the lugs by connecting members, whereby the working head can be rotated relative to the lugs for multiangular operation, the ratchet head being formed with a central axial through hole in which a driving head is slidably fitted.

2. The rotary wrench structure as claimed in claim 1, wherein two opposite ends of the pawl block and the slide block respectively have a first boss and a second boss, two ends of the resilient member being respectively fitted on the first and second bosses to interconnect the pawl block and the slide block.

3. The rotary wrench structure as claimed in claim 2, wherein the resilient member is a leaf spring or a compression spring.

4. The rotary wrench structure as claimed in claim 1, wherein each lug has a locating hole, two opposite ends of the locating holes respectively having two stopper flanges, a circumference of the working head being formed with two inner connecting sections, each connecting member having an outer connecting section at one end, the outer thread sections being passed through the locating holes of the lugs and connected with the inner connecting sections of the working head.

5. The rotary wrench structure as claimed in claim 1, wherein a restricting member is embedded in a sidewall of the through hole of the ratchet head, one side of the driving head being formed with a flute facing the restricting member, the restricting member being slidably inlaid in the flute.

6. The rotary wrench structure as claimed in claim 1, wherein another sidewall of the through hole of the ratchet head opposite to the restricting member is formed with a second locating hole, two resilient units being embedded in another side of the driving head opposite to the flute, the driving head being slidable within the through hole of the ratchet head to coaxially align one of the resilient units with the second locating hole, whereby the resilient unit can get into the second locating hole so as to locate the driving head.

7. The rotary wrench structure as claimed in claim 1, wherein two opposite ends of the pawl block and the slide block are respectively formed with two locating channels, each end of the resilient member having a locating section, whereby the locating sections are respectively fitted in the locating channels of the pawl block and the slide block.

8. The rotary wrench structure as claimed in claim 7, wherein the resilient member is a U-shaped spring.

9. A rotary wrench structure comprising:
a main body having a handle section at one end and two lugs at the other end, the two lugs defining therebetween a holding space, a split communicating with the holding space and extending therefrom to the handle section; and
a working head having a receiving space in which a ratchet head is accommodated, a circumference of the ratchet head being formed with multiple ratchets, at least one cavity being formed on a sidewall of the receiving space, at least one pawl unit being mounted in the cavity, the pawl unit including a pawl block, a slide block and a resilient member, one side of the pawl block being formed with several ratchets facing the ratchet head, one side of the slide block being formed with an arced face facing the ratchet head, the pawl block and the slide block being interconnected by the resilient member, whereby the ratchets of the pawl block serve to engage with the ratchets of the ratchet head for driving the ratchet head, a stopper member being mounted at a bottom end of the ratchet head for locating the ratchet head in the receiving space, the ratchet head being formed with a central axial through hole in which a driving head is slidably fitted, a restricting member being embedded in a sidewall of the through hole of the ratchet head, one side of the driving head being formed with a flute facing the restricting member, the restricting member being slidably inlaid in the flute, the ratchet head being formed with a radial through hole in which the restricting member is accommodated, a second resilient unit and a third resilient unit being disposed in the flute in proper positions, the second resilient unit being positioned near the bottom of the flute, while the third resilient unit being positioned near the top of the flute, whereby the second resilient unit and the third resilient unit define therebetween a restricting flute, the restricting member being fitted in the restricting flute, permitting the driving head to axially move between the second resilient unit and the third resilient unit, the working head being rotatably connected with the lugs by connecting members, whereby the working head can be rotated relative to the lugs for multiangular operation.

10. The rotary wrench structure as claimed in claim 9, wherein two opposite ends of the pawl block and the slide block respectively have a first boss and a second boss, two ends of the resilient member being respectively fitted on the first and second bosses to interconnect the pawl block and the slide block.

11. The rotary wrench structure as claimed in claim 9, wherein each lug has a locating hole, two opposite ends of the locating holes respectively having two stopper flanges, a circumference of the working head being formed with two inner connecting sections,

12. The rotary wrench structure as claimed in claim 9, wherein two opposite ends of the pawl block and the slide block are respectively formed with two locating channels, each end of the resilient member having a locating section, whereby the locating sections are respectively fitted in the locating channels of the pawl block and the slide block.

13. The rotary wrench structure as claimed in claim 9, wherein the restricting member is an insertion pin.

14. The rotary wrench structure as claimed in claim 9, wherein each resilient unit includes a compression spring and a ball body.

15. The rotary wrench structure as claimed in claim 9, wherein the flute is an open flute and formed on one side of the driving head.

16. The rotary wrench structure as claimed in claim 10, wherein the resilient member is a leaf spring or a compression spring.

17. The rotary wrench structure as claimed in claim 12, wherein the resilient member is a U-shaped spring.
